(19) United States
(12) Patent Application Publication
(10) Pub. No.: US 2021/0345033 A1
(43) Pub. Date: Nov. 4, 2021

(54) PORTABLE AUDIO EQUIPMENT

(71) Applicant: LG ELECTRONICS INC., Seoul (KR)

(72) Inventors: Hyunseung YU, Seoul (KR); Dongsung KIM, Seoul (KR); Donguk JEONG, Seoul (KR)

(73) Assignee: LG ELECTRONICS INC., Seoul (KR)

(21) Appl. No.: 17/282,534

(22) PCT Filed: Oct. 19, 2018
(86) PCT No.: PCT/KR2018/012384

§ 371 Date: Apr. 2, 2021

(51) Int. Cl. H04R 1/10; H04R 1/02; H04R 1/44

(52) U.S. Cl. CPC H04R 1/1083; H04R 1/02; H04R 2420/07; H04R 1/1016; H04R 1/44; H04R 1/1075

(57) ABSTRACT

A mobile terminal comprises: a housing; an audio channel protruding from one side of the housing, one end of the audio channel being open; an audio bracket comprising a first portion inserted into the audio channel and a second portion positioned inside the housing; an audio output portion seated on a first seating portion of the audio bracket; an internal microphone seated on a second seating portion of the audio bracket; and a controller mounted inside the housing so as to control the audio output portion such that sounds are output, the controller processing sounds collected from the internal microphone. The audio bracket comprises: a barrier included in the first portion so as to delimit the audio channel into a first audio channel and a second audio channel; the first seating portion connected to the first audio channel and formed on the second portion; and the second seating portion connected to the second audio channel and positioned on the first portion. The mobile terminal further comprises an internal microphone for collecting sounds input through the user's body such that external noise can be removed more effectively.

### TECHNICAL FIELD

The present disclosure relates to a portable audio equipment configured to receive an audio signal from a terminal through wireless communication with the terminal and transmit a control signal for controlling the terminal.

### BACKGROUND ART

A portable audio equipment means an audio device that receives sound signals from a terminal and transmits sound information collected through a microphone to the terminal. In the related art, a portable audio device uses a wired mechanism of receiving a sound signal by putting a plug into an ear jack, but the demand for wireless portable audio equipments has been increasing recently in terms of mobility and ease of use.

A portable audio equipment consists of an audio output unit to perform functions such as music playback, telephone conversation, etc. The portable audio equipment may connect itself to a base station to make phone calls, directly to an external server to obtain audio data, and perform the above functions through pairing by connecting to another terminal.

Ongoing efforts are made to develop portable audio equipments with designs that consider portability, such as a headphone type put on a head in a band shape, an ear-hung type, an ear-fit type and the like, which can be carried on a user's body.

A portable audio equipment not only output sounds, but also collects user's voice through a microphone to store or transmit it to a person on the phone. In doing so, various algorithms are used to distinguish user's voice from external noise, and it is intended to physically dispose a plurality of microphones at optimal locations. However, due to the miniaturization of a portable audio equipment, the placement of microphones is limited, thereby making it difficult to collect optimal sounds.

### DISCLOSURE OF THE INVENTION

### Technical Task

One technical task of the present disclosure is to provide a portable audio equipment additionally including an in-ear microphone in a limited space in receiving an audio signal from a terminal through wireless communication with the terminal and transmitting a control signal for controlling the terminal.

### Technical Solutions

In one technical aspect of the present disclosure, provided is a portable audio equipment, including a housing, an audio path projected from one side of the housing and having one open end portion, an audio bracket including a first part having the audio path inserted therein and a second part located within the housing, an audio output unit installed in a first seating part of the audio bracket, an inner microphone installed in a second seating part of the audio bracket, and a controller installed in the housing, the controller configured to control the audio output unit to output a sound and process a sound collected from the inner microphone, wherein the audio bracket may include a partition included in the first part and partitioning the audio path into a first audio path and a second audio path, the first seating part connected to the first audio path and formed in the second part, and the second seating part connected to the second audio path and including the second seating part located in the first part.

The first audio path may be larger than the second audio path.

The first audio path and the second seating part may be located on one side of the partition, the second audio path may be located on the other side of the partition, and a length of the first audio path may be shorter than a length of the second audio path by a length of the second seating part.

At least one of the first audio path or the second audio path may be formed in a cylindrical shape.

The second part of the audio bracket may include a coupling surface of a plane touching an inner surface of the housing by being extended from an end portion of the first part and further include a waterproofing tape interposed on the coupling surface.

An opening for collecting a sound may be formed in a lateral direction of the inner microphone.

The portable audio equipment may further include at least one outer microphone located on the other side of the housing and the controller may distinguish a user's voice and an external noise from each other using a difference of sounds collected by the inner microphone and the outer microphone.

### Advantageous Effects

A portable audio equipment according to the present disclosure further includes an inner microphone for collecting sound inputted through a user's body, thereby eliminating external noise more effectively.

In addition, a length of a second audio path is short, whereby collection of sound through a microphone is further facilitated.

In addition, a sound outputted from an audio output unit may be prevented from flowing into an inner microphone using a partition. In addition, as a waterproofing tape is usable for the adhesion between an audio bracket and a housing, it is advantageous in that such a member as a waterproofing ring and the like is unnecessary.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### DESCRIPTION OF DRAWINGS

FIG. 1 is a block diagram showing the configuration of a portable audio equipment according to the present disclosure.

FIG. 2 is a perspective diagram of a portable audio equipment according to one embodiment of the present disclosure, viewed in one direction.

FIG. 3 is an exploded perspective diagram of a portable audio equipment according to one embodiment of the present disclosure.

FIG. 4 is a diagram to describe collection of sounds spoken by a user through a plurality of microphones.

FIG. 5 is a diagram showing a portable audio equipment having a third microphone.

FIG. 6 is a diagram showing a portable audio equipment according to one embodiment of the present disclosure.

FIG. 7 is a diagram showing a state that an audio bracket, a microphone and a speaker are coupled together.

### BEST MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

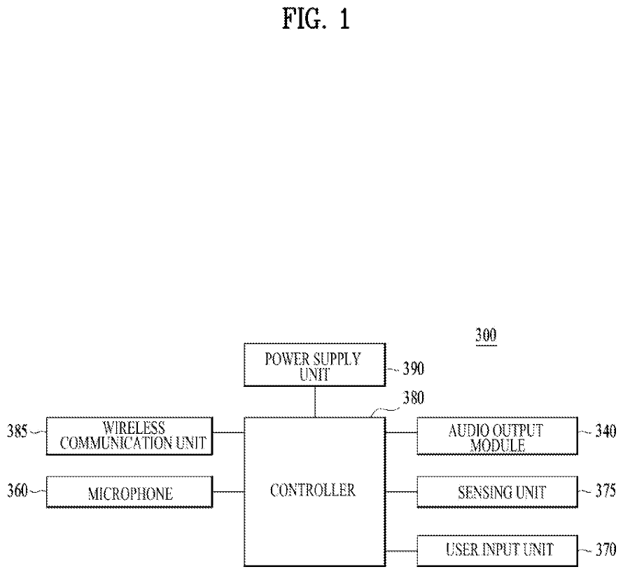

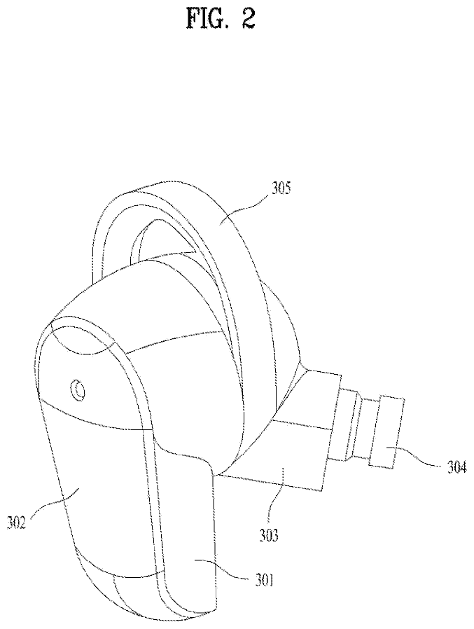

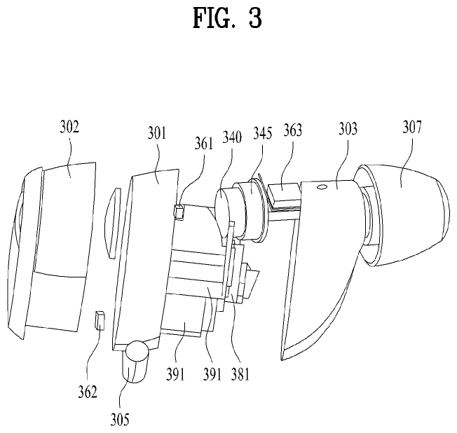

FIG. 1 is a block diagram of a portable audio equipment 300 according to the present disclosure. FIG. 2 is a perspective diagram of the portable audio equipment 300 according to one embodiment of the present disclosure, viewed in one direction. FIG. 3 is an exploded perspective diagram of the portable audio equipment 300 according to one embodiment of the present disclosure. For clarity of the description of configurations of the portable audio equipment 300 related to FIG. 1, FIG. 2 and FIG. 3 are referred to together.

A portable audio equipment 300 according to the present disclosure includes a controller 380, a wireless communication unit 385, an audio output unit (or module) 340, a sensing unit 375, a microphone 360, a user input unit 370, and a power supply unit 390.

The portable audio equipment 300 according to the present disclosure includes a plurality of cases 301 to 303, and the cases are coupled together to form a housing that includes an inner space in which electronic parts are installed. The second case 302 coupled to one side of the first case 301 is a part externally exposed when a user wears the portable audio equipment 300, and the audio output unit 340 outputting sounds according to audio signals is located on the other side of the first case 301 so as to form an audio path for transmitting a sound to the user. To facilitate the installation of parts (e.g., the audio output unit) in the first case 301, a separate case 303 may be configured in a manner that a portion at which the audio path 304 is located is separated.

The portable audio equipment 300 according to the present disclosure may include the audio path 304 projected in a kernel to be insertable into a user's external auditory meatus, and an ear tip 307 may be coupled to an outside of the audio path 304 so as to closely adhere to a user's ear.

The microphone 360 processes an external audio signal into an electrical audio data. The processed audio data is forwarded to an external terminal or server through the wireless communication unit 385. Various noise cancellation algorithms for cancelling noises generated in the course of receiving an input of an external audio signal may be implemented in the microphone 360.

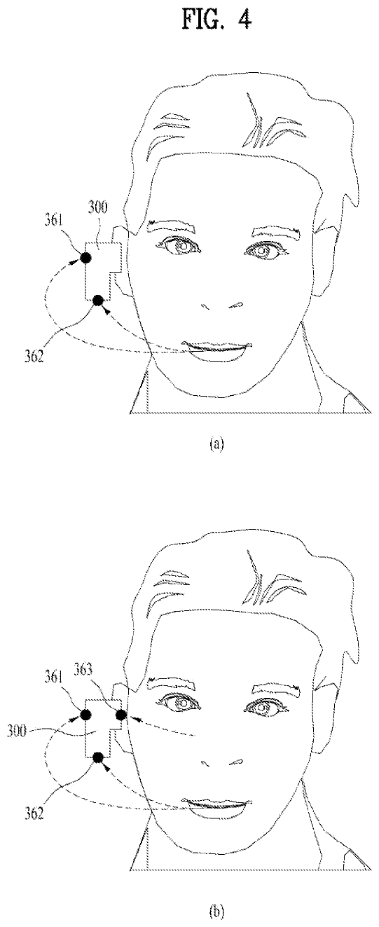

FIG. 4 is a diagram to describe collection of sounds spoken by a user through a plurality of microphones. FIG. 4 (a) shows a case that two microphones are provided, and FIG. 4 (b) shows a case that three microphones are provided.

A plurality of the microphones 360 of the present disclosure are provided to cancel noises by combining various sounds. As shown in FIG. 4 (a), two microphones 361 and 362 are disposed at different locations, respectively, whereby a sound spoken by a user and an external noise can be distinguished from each other using a time difference, a volume difference and the like between the sounds collected by the microphones 361 and 362.

Additionally, as shown in FIG. 4 (b), a third microphone 363 collecting sounds transmitted through the Eustachian tube connecting user's mouth and ear together is further included, whereby external noises can be eliminated in a manner of combining the sounds collected by the externally located microphones 361 and 362 and the sounds collected by the third microphone 363 together. Particularly, the sounds collected by the third microphone 363 may include a smallest external noise and a user's voice collected loudest, thereby having an optimal structure in eliminating external noises.

The sensing unit 375 is a device for recognizing a state of the portable audio equipment 300 and may include an illumination sensor sensing ambient brightness, a touch sensor sensing a touch input, a gyro sensor sensing an inclination and location of the portable audio equipment 300 and the like.

The user input unit 370 is an input unit for a user to control the portable audio equipment 300. The portable audio equipment 300 in small size like the present disclosure may extend combinations of a button-pressed time, a button-pressed count and a plurality of buttons into inputtable control commands using a touch mechanism or a limited number of buttons.

The power supply unit 390 supplies power necessary for the controller and the respective parts and may use a battery 391 of a button type to install in a small space. As a size of the battery 391 determines a use time of the portable audio equipment 300, it is necessary to secure a space as large as possible. Hence, some boards are disposed in a manner of being overlaid, thereby enlarging an available installation space. A power terminal for connection to an external power source may be included to charge the battery 391. The power terminal comes into contact with a power terminal formed in a cradle in which the portable audio equipment 300 is installed, thereby receiving a power from the external power source.

A printed circuit board 381 is located as the controller 380 in a housing and a plurality of ICs are mounted on the printed circuit board 381. Thus, if the printed circuit board 381 is disposed in a manner of being overlaid with the battery 391, it causes a problem of increased thickness. Therefore, a flexible board 382 disposed not to be overlaid with the battery 391 is usable for the installation and connection of some components such as the microphone 360, the user input unit 370, the audio output unit 340 and the like.

The wireless communication unit 385 means a device for wireless communication with another terminal or a base station and may include an antenna for transmission and reception of wireless signals. If the antenna contacts with a user's body, radiation performance is lowered. Hence, the antenna may be located in the second case 302 that can avoid contacting with the user's body on wearing.

It is able to use a main bracket 385 to fix the flexible board 382, the printed circuit board 381, the battery 391, the microphone and the like thereto. Installation may be facilitated by forming a single assembly in a manner of installing the printed circuit board 381, the battery 391, the flexible board 382, the microphones 361 and 362 and the like in the main bracket 385 and then installing the assembly in the housing.

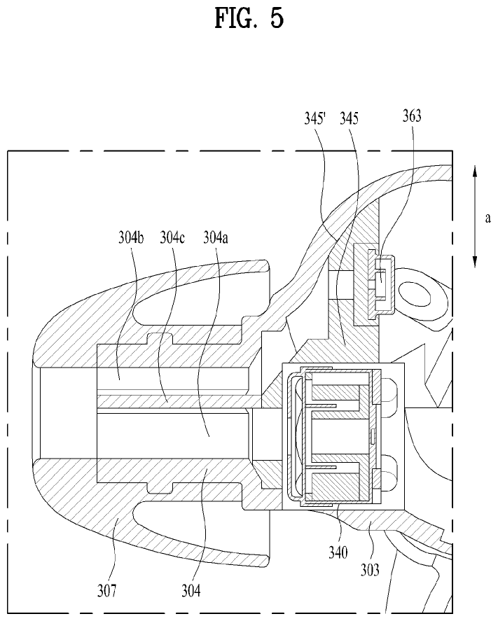

FIG. 5 is a diagram showing the portable audio equipment 300 having the third microphone 363. The third microphone 363 may be disposed adjacent to the audio path 304 so that a user's voice can be collected through an external auditory meatus of an ear through the Eustachian tube other than the first and second microphones 361 and 362 located outside.

Yet, in case that a sound outputted from the audio output unit 340 enters the third microphone 363, it causes a problem that a sound collected by the third microphone 363 is mixed with noise. As shown in FIG. 5, a partition is formed in the audio path, thereby dividing the audio path into a first audio path 304a and a second audio path 304b. Thus, the audio path 304 may be partitioned in a manner that a sound outputted from the audio output unit 340 is outputted along the first audio path 304a and that a user's voice arrives at the third microphone 363 through the second audio path 304b.

Thus, in case that the audio path 304 is divided by the partition 304c, a noise caused by a sound outputted from the audio output unit 340 may be advantageously reduced in a sound collected by the third microphone 363. If the thickness of the partition 304c is increased, a size of the sound outputted from the audio output unit 340 and entering the third microphone 363 may be minimized. Yet, if so, the audio path 304 may be excessively narrowed. Therefore, the thickness of the partition 304c may be set in consideration of both aspects.

To enable a sound outputted from the audio output unit 340 to be released sufficiently, a cross-section of the first audio path 304a may be configured twice greater than that of the second audio path 304b.

An audio bracket 345 may be further included to enable the audio output unit 340 and the microphone to be precisely disposed in the first audio path 304a and the second audio path 304b. The audio bracket 345 includes a hole connected to the first audio path 304a and the second audio path 304b. Regarding the third microphone 363 connected to the second audio path 304b, as shown in FIG. 5, the audio bracket 345 may be provided with a supplementary audio path 346 connected to a location of the third microphone 363.

As the third microphone 363 is additionally disposed at an end portion of the audio path 304, a size of a portion of the audio path 304 extended from the housing 303 is increased to secure a space for installing the microphone therein (a). As shown in FIG. 5, if a portion of the housing 301 to 303 adjacent to the audio path 304 is increased, it may cause a problem that user's wearing sensation is degraded and a problem that the portable audio equipment is separated from an ear. To solve the above problems, as shown in FIG. 5, the third microphone 363 may be placed slightly inward, but a length of the second audio path 304b is further increased inevitably.

If the length of the second audio path 304b is increased, it may cause a problem that sound collection capability of the microphone is lowered. If the length of the second audio path 304b is increased, a resonant frequency of the second audio path 304b is decreased. If the resonant frequency is lowered, a range of sounds collectable by the microphone is decreased, whereby the sound collection capability of the microphone is degraded.

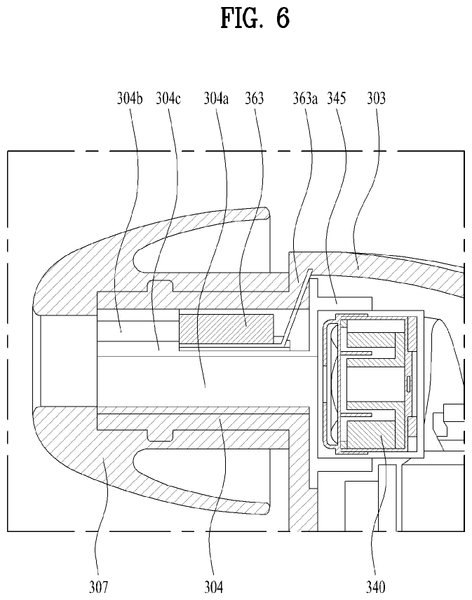

FIG. 6 is a diagram showing the portable audio equipment 300 according to one embodiment of the present disclosure. To decrease the length of the second audio path 304b as well as to reduce a size of the third case 303 adjacent to the audio path 304, as shown in FIG. 6, the third microphone 363 may be disposed in the audio path 304. A second seating part on which the third microphone 363 is seated may be formed by omitting a portion of the second audio path 304b.

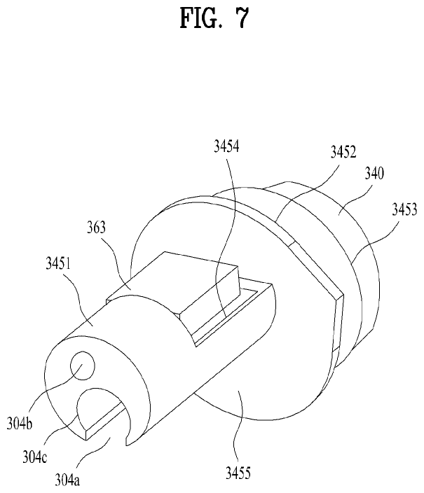

To dispose the audio output unit 340 and the third microphone 363 near the audio path 304 of the present disclosure, an audio bracket 345 on which the audio output unit 340 and the third microphone 363 are seated may be included. FIG. 7 is a diagram showing a state that the audio bracket 345, the third microphone 363 and the speaker are coupled together. The audio bracket 345 includes a first part 3451 inserted in the audio path 304 and a second part 3452 located inside the case 303.

The first part 3451 may have a cylindrical shape configured long in one direction to correspond to a shape of the audio path 304. If the audio path 304 has a cylindrical shape, as shown in FIG. 7, the first part 3451 may have a cylindrical shape. The first sound path 304a and the second audio path 304b may be formed in a cylindrical shape in the first part 3451 of the audio bracket 345 to enable sounds to be transmitted without distortion. Like the second audio path 304b, the audio bracket 345 may be configured in a manner of enclosing an entire outer circumference of the audio path. Like the first audio path 304a, a portion of the audio path of the case may be configured in a manner of being enclosed by the audio bracket 345.

As shown in FIG. 6, with the partition 304c in the middle, the first audio path 304a may be located on one side and the second audio path 304b and the third microphone 363 may be located on the other side. A length of the second audio path 304b is shorter than the first audio path 304a by a length of the second seating part on which the third microphone 363 is mounted. As described above, if the length of the second audio path 304b is short, a resonant frequency of the second audio path 304b increases, whereby a band of a collectable sound is widened advantageously.

As the third microphone 363 is located on the audio path 304, the third microphone 363 and the printed circuit board 381 in the housing 301 to 303 may be connected using a flexible board. And, the flexible board may perforate the audio bracket 345 or the third case 303 or pass between the housing 303 and the audio bracket 345.

As shown in FIG. 5, although a general microphone has an opening formed on a wide top surface to collect sounds, since the third microphone 363 of the present embodiment should be disposed in the narrow audio path 304, the third microphone 363 may use a configuration having an audio hole formed in a lateral direction to enable a sound to enter.

A first seating part 3453 on which the audio output unit 340 is seated is located at the second part located on the housing side. The first seating part 3453 may include an opening to communicate with the first audio path 304a.

As shown in FIG. 5, when contact between the audio bracket 345 and the case 303 is made with curved surfaces, if a waterproofing tape is used for waterproofing, a gap may be generated in between to cause a problem that the reliability of the waterproofing is degraded. As the audio bracket 345 shown in FIG. 6 may be configured in a manner that the second part 3452 and a part 3455 touching an inner surface of the case 303 form a plane, a waterproofing structure can be simply implemented using a waterproofing tape.

As described above, the portable audio equipment 300 of the present disclosure further includes an inner microphone configured to collect a sound inputted through a user's body, thereby cancelling external noises more effectively.

In addition, as the length of the second audio path 304b is short, sound collection through a microphone is further facilitated advantageously.

In addition, a sound outputted from the audio output unit may be prevented by the partition from entering the inner microphone. In addition, since a waterproofing tape is usable for the adhesion between the audio bracket and the housing, such members as a separate waterproofing ring and the like are unnecessary advantageously.

The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A portable audio equipment, comprising:
a housing;
an audio path projected from one side of the housing and having one open end portion;
an audio bracket including a first part having the audio path inserted therein and a second part located within the housing;
an audio output unit installed in a first seating part of the audio bracket;
an inner microphone installed in a second seating part of the audio bracket; and
a controller installed in the housing, the controller configured to control the audio output unit to output a sound and process a sound collected from the inner microphone,
wherein the audio bracket comprises a partition included in the first part and partitioning the audio path into a first audio path and a second audio path, the first seating part connected to the first audio path and formed in the second part, and the second seating part connected to the second audio path and including the second seating part located in the first part.

2. The portable audio equipment of claim 1, wherein the first audio path is larger than the second audio path.

3. The portable audio equipment of claim 1, wherein the first audio path and the second seating part are located on one side of the partition, wherein the second audio path is located on the other side of the partition, and wherein a length of the first audio path is shorter than a length of the second audio path by a length of the second seating part.

4. The portable audio equipment of claim 1, wherein at least one of the first audio path or the second audio path has a cylindrical shape.

5. The portable audio equipment of claim 1, wherein the second part of the audio bracket includes a coupling surface of a plane touching an inner surface of the housing by being extended from an end portion of the first part and further includes a waterproofing tape interposed on the coupling surface.

6. The portable audio equipment of claim 1, wherein an opening for collecting a sound is formed in a lateral direction of the inner microphone.

7. The portable audio equipment of claim 1, further comprising at least one outer microphone located on the other side of the housing and wherein the controller distinguishes a user's voice and an external noise from each other using a difference of sounds collected by the inner microphone and the outer microphone.
